(19) United States
(12) Patent Application Publication
(10) Pub. No.: US 2005/0269016 A1
(43) Pub. Date: Dec. 8, 2005

(54) Automated forming of pre-impregnated composite structural elements

(75) Inventors: Tino Oldani, Rockford, IL (US); Daniel Jarvi, Rockford, IL (US)

Correspondence Address: REINHART BOERNER VAN DEUREN LTD., 483 NORTH MULFORD ROAD, SUITE 7, ROCKFORD, IL, 61107, US

(73) Assignee: Ingersoll Machine Tools, Inc., Rockford, IL (US)

(21) Appl. No.: 11/111,697

(22) Filed: Apr. 21, 2005

Related U.S. Application Data
(60) Provisional application No. 60/564,156, filed on Apr. 21, 2004.

(51) Int. Cl. B29C 67/20; C09J 1/00; B32B 31/00

(52) U.S. Cl. 156/182; 264/175; 156/272.2

(57) ABSTRACT

An improved automated method and apparatus are provided for forming composite structures, by calendering two or more elements of a pre-impregnated composite material into a band of uncured composite material, and then forming the uncured band of composite material into one or more formed, uncured composite structures.

### CROSS-REFERENCE TO RELATED PATENT APPLICATIONS

This patent application claims the benefit of U.S. Provisional Patent Application No. 60/564,156, filed Apr. 21, 2004, the teachings and disclosure of which are hereby incorporated in their entireties by reference thereto.

### FIELD OF THE INVENTION

This invention relates to forming composite structural elements, and more particularly to automated forming of uncured, pre-impregnated, green, composite structural elements.

### BACKGROUND OF THE INVENTION

In order to facilitate the manufacture of structures formed from composite materials, it is sometimes desirable to assemble intricate structures from component parts formed from pre-impregnated composite materials, which are still in the uncured, or “green”, state, prior to curing the entire assembled structure simultaneously. Such construction techniques can result in simplification of the overall construction, and can also result in improved structural capabilities of the finished composite part. For example, during fabrication of structures such as sections of an aircraft fuselage, or a boat hull, it may be desirable to place uncured composite stringers on an uncured composite sheet panel. Additional uncured, or pre-cured, shaped components may also be attached, prior to inserting the entire assembly into a vacuum bag for co-curing of the entire structure.

In order to facilitate such construction, it is desirable to have an improved method and apparatus for forming uncured, or green, composite structural elements from pre-impregnated composite fibers, tapes, or cloth. It is further desirable to have an automated process for forming such uncured structural elements.

### BRIEF SUMMARY OF THE INVENTION

The invention provides an improved automated method and apparatus for forming composite structures, by calendering two or more elements of a pre-impregnated composite material into a band of uncured composite material, and then forming the uncured band of composite material into one or more formed, uncured composite structures.

A method, according to the invention, may further include curing the formed, uncured composite structures.

The invention may further include a method and/or apparatus for cutting the band of uncured composite material prior to forming and/or after forming.

The invention may also provide a method and/or apparatus for depositing the one or more formed, uncured composite structures onto a curing tool. A method and/or apparatus, according to the invention, may further provide for indexing the curing tool as the one or more uncured composite structures are deposited on the curing tool. The uncured composite material may be cut to form two or more uncured composite structures, and the curing tool indexed in such a manner that the two or more uncured composite parts are separated from one another on the curing tool. The invention may further provide for placement of a composite sheet panel, which is preferably also in an uncured state, onto the curing tool, prior to depositing the uncured composite structures thereupon.

An apparatus, according to the invention, may further include a controller for controlling the apparatus in such a manner that two or more uncured composite parts, formed in accordance with the invention, are separated from one another on the curing tool.

Other aspects, objectives and advantages of the invention will become more apparent from the following detailed description when taken in conjunction with the accompanying drawings.

### BRIEF DESCRIPTION OF THE DRAWINGS

FIG. 1 is a perspective illustration of an exemplary embodiment of an apparatus for forming composites, according to the invention.

FIG. 2 is a schematic representation of the exemplary embodiment of the apparatus shown in FIG. 1.

FIG. 3A is a perspective illustration of an exemplary embodiment of an uncured composite structure, in the form of a stringer, having a hat-shaped cross section, formed in accordance with the invention.

FIG. 3B is an enlarged view of a trimmed edge of the stringer of FIG. 3A.

FIG. 4 is a perspective illustration of a portion of an aircraft fuselage panel during construction thereof, having a plurality of hat-shaped stringers, such as those shown in FIG. 3A, attached to an uncured sheet of composite material.

FIGS. 5A-5C are schematic representations of the manner in which a progressive roll-forming mechanism of the exemplary embodiment of the apparatus shown in FIGS. 1 and 2 is utilized, according to the invention, for forming the uncured, hat-shaped, stringers of FIG. 3A.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

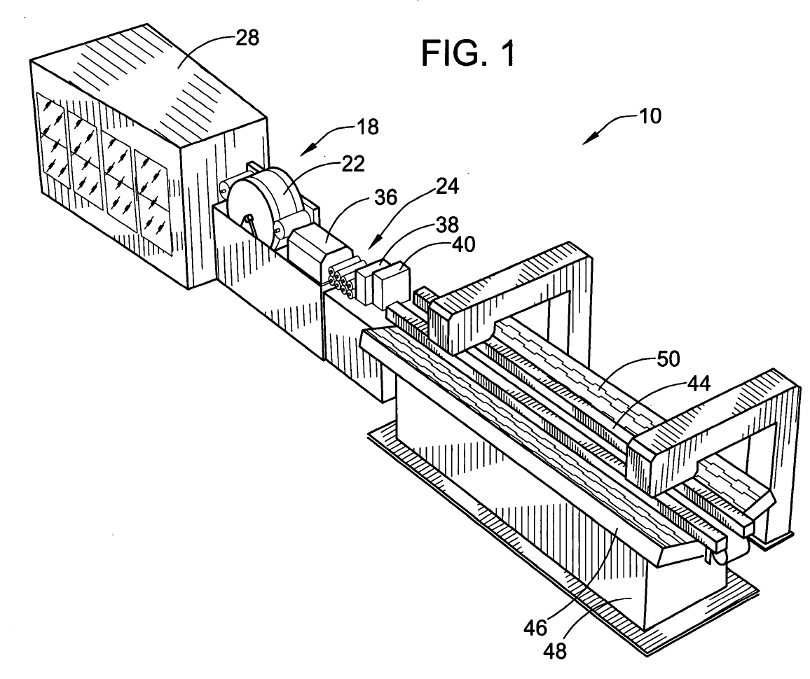

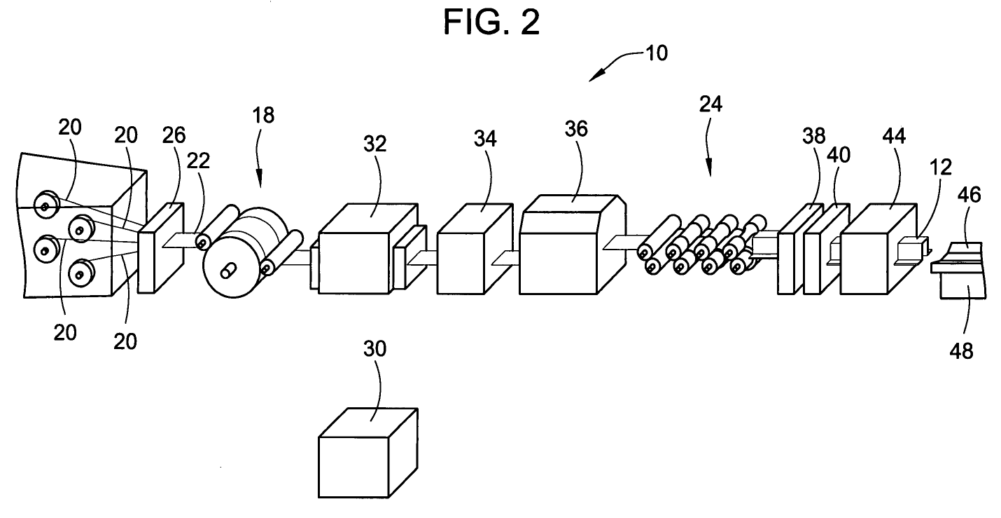

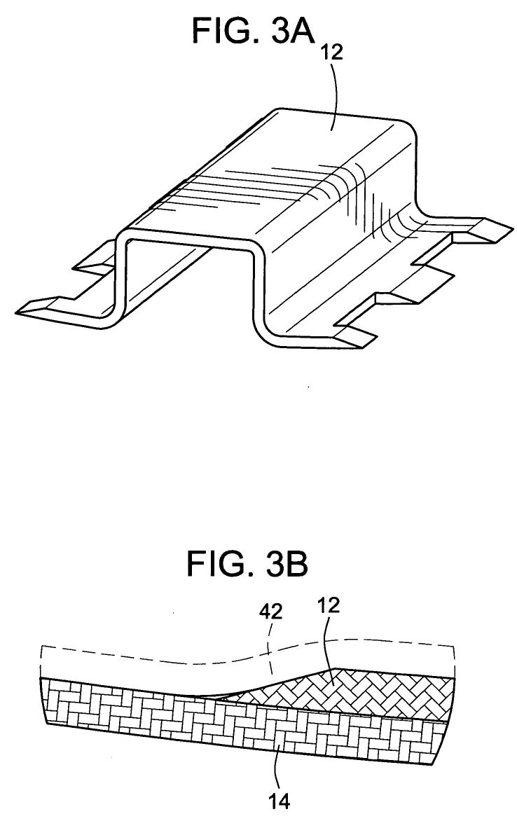

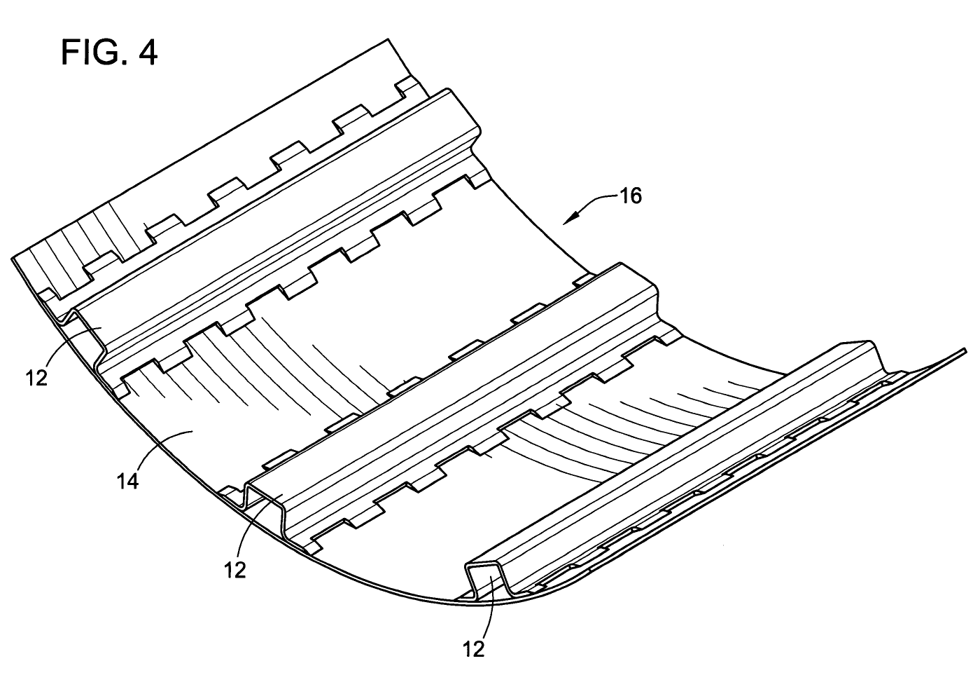

FIGS. 1 and 2 show a first exemplary embodiment of an apparatus 10 for forming composite structures, in the form of a stringer 12, as shown in FIG. 3A, from layers of uncured pre-impregnated composite material. The stringer 12 is then attached, while still in an uncured state, to an uncured sheet 14 of composite material, and subsequently co-cured with the sheet 14 to form a fuselage panel 16 for an aircraft.

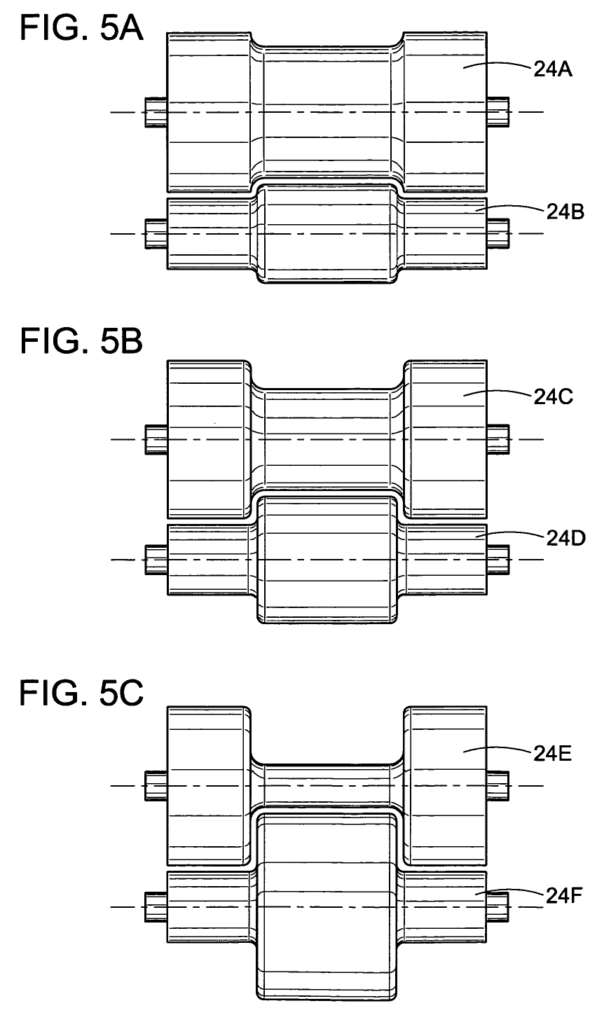

As shown in FIGS. 1 and 2, the apparatus 10 includes a roller-type calender for consolidating a desired combination of two or more elements 20 of pre-impregnated composite material into a band 22 of uncured composite material, and a progressive roll-forming mechanism 24, for forming the uncured band 22 of composite material into one or more formed, uncured stringers 12, having the hat-shaped cross section shown in FIG. 3A. FIGS. 5A-5C illustrate the manner in which the band 22 of uncured composite material is roll-formed, into the hat-shape shown in FIG. 3A, by passing sequential through roller sets 24A,B,24C,D,and 24E,F.

The apparatus 10 also includes a cut-and-add mechanism 26 for receiving multiple elements 20 of pre-impregnated composite material, and supplying the desired combination of two or more elements 20 of pre-impregnated composite material to the calender 18. The multiple elements 20 of pre-impregnated composite material are stored on spools in an environmentally controlled creel 28. Although a single reference 20 has been utilized to designate all of the multiple elements 20 of pre-impregnated composite material in the exemplary embodiment of the apparatus 100, the elements 20, need not all be identical in practicing the invention. For example, some of the elements may be fabricated from a material such as pre-impregnated carbon fiber tape or tows, whereas others of the elements 20 may be other types of pre-impregnated composite materials, such as bias woven fabric, interwoven wire fabric, surfacers, glass or Kevlar fiber sheet, tapes, films, or tows. A controller 30 of the apparatus 10, is used for controlling the cut-and-add mechanism 26 for selectively choosing two or more desired ones of the composite elements 20 for consolidation by the calender to form the band 22 of uncured pre-impregnated material.

A capstan drive mechanism 32 is provided, in the exemplary embodiment of the apparatus 10, to facilitate movement of the band 22 of material through the apparatus 10. In some embodiments of the invention, the function of the capstan drive may be sufficiently performed by other elements of the apparatus 10 to allow elimination of the separate capstan drive 32.

The exemplary apparatus 10 also includes a band cutter 34, for selectively cutting the band 22 of uncured composite material prior to forming, and a heater 36 for heating the band 22 of uncured composite material prior to forming. A pair of formed part cutters 38, 40 are provided for selectively cutting the formed uncured composite material, subsequent to forming by the roll-forming mechanism, to trim the edges of the stringers 12 to a desired shape, and also for cutting the stringers 12 to a desired length. Although any appropriate cutter may be utilized in practicing the invention, it is contemplated that a pair of ultrasonic cutters 38, 40, mounted on numerically controlled axes may preferably be used to cut the stringers 12 to length, and for cutting the edges of the stringers to form a desired contour and profile. As shown in FIGS. 3A and 3B, the flanges of the hat-shaped uncured stringers 12 are profile cut into a shape which is advantageous to formation of the fuselage panel 16. The outer edges of the flanges of the stringers 12 are also angle-cut on a bias as shown in FIG. 3B to provide an advantageous fit with additional components of the fuselage panel, indicated by the dashed line 42 in FIG. 3B.

As shown in FIGS. 1 and 2, the exemplary embodiment of the apparatus 10 also includes a conveyer mechanism 44, having a split belt arrangement (not shown), for delivering the severed stringer 12 onto a curing tool 46. An indexer 48 is also provided and operatively connected to the curing tool 46, for indexing the curing tool 46 as each of the uncured composite stringers 12 are deposited onto the curing tool 46.

In the exemplary embodiment of the invention shown in FIG. 1, the curing tool 46 is adapted to receive the sheet of material 14 on its surface, and to then have an adhesive 50 selectively applied to the upper surface of the sheet 14 for use in bonding the stringers 12 to the sheet 14. The indexer 48 moves the curing tool 46 transversely across the longitudinal axis of the apparatus 10 to appropriately position the sheet 14 such that as each stringer 12 is released by the conveyer mechanism 44, the stringer 12 is placed in an appropriated desired position on the sheet 14, and spaced from an adjacent stringer 12.

Cooperation between the various components of the exemplary embodiment of the apparatus 10 is controlled and coordinated by the aforementioned controller 30.

Although the invention has been presented herein in conjunction with certain exemplary embodiments, for forming a hat-shaped stringer 12 of uncured pre-impregnated composite material, those having skill in the art will recognize that a method and/or apparatus according to the invention provides significant advantage in automated forming of pre-impregnated composite structural elements having a virtually unlimited variety of other shapes. These may be spars, floor beams, angles, channels, etc.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for forming composite structures, the method comprising:
calendering two or more elements of pre-impregnated composite material into a band of uncured composite material; and
forming the uncured band of composite material into one or more formed, uncured composite structures.

2. The method of claim 1, further comprising curing the formed, uncured composite structures.

3. The method of claim 1, further comprising cutting the band of uncured composite material, prior to forming.

4. The method of claim 1, further comprising cutting the band of uncured composite material, subsequent to forming.

5. The method of claim 1, further comprising depositing the one or more formed, uncured composite structures onto a curing tool.

6. The method of claim 5, further comprising curing the formed, uncured composite structures.

7. The method of claim 5, further comprising cutting the uncured composite material prior to depositing the one or more formed uncured, composite structures on the curing tool.

8. The method of claim 7, further comprising indexing the curing tool as the one or more uncured composite structures are deposited onto the curing tool.

9. The method of claim 8, further comprising cutting the uncured composite material to form two or more uncured composite structures, and indexing the curing tool in such a manner that the two or more uncured composite parts are separated from one another on the curing tool.

10. An apparatus for forming composite structures, the apparatus comprising:
a calender, for consolidating a desired combination of two or more elements of pre-impregnated composite material into a band of uncured composite material, and
a forming mechanism, for forming the uncured band of composite material into one or more formed, uncured composite structures.

11. The apparatus of claim 10, wherein the forming mechanism is a progressive roll former.

12. The apparatus of claim 10, further comprising a cut-and-add mechanism for receiving multiple elements of pre-impregnated composite material and supplying the desired combination of two or more elements of pre-impregnated composite material to the calender.

13. The apparatus of claim 12, further comprising a creel for storing the multiple elements of pre-impregnated composite material and for supplying the multiple elements of pre-impregnated composite material to the cut-and-add mechanism.

14. The apparatus of claim 10, further comprising a band cutter for cutting the band of uncured composite material, prior to forming.

15. The apparatus of claim 10, further comprising a formed-part cutter for cutting the formed, uncured composite material, subsequent to forming.

16. The apparatus of claim 10, further comprising a conveyor for depositing the one or more, formed, uncured composite structures onto a curing tool.

17. The apparatus of claim 16, further comprising a cutter for cutting the uncured composite material prior to depositing the one or more formed uncured, composite structures onto the curing tool.

18. The apparatus of claim 17, further comprising an indexer, operatively connected to the curing tool, for indexing the curing tool as the one or more uncured composite structures are deposited onto the curing tool.

19. The apparatus of claim 18, further comprising a controller for controlling the apparatus in such a manner that the two or more uncured composite parts are separated from one another on the curing tool.

20. An apparatus for forming composite structures, the apparatus comprising:
a roller-type calender, for consolidating a desired combination of two or more elements of pre-impregnated composite material into a band of uncured composite material;
a progressive roll forming mechanism, for forming the uncured band of composite material into one or more formed, uncured composite structures;
a cut-and-add mechanism for receiving multiple elements of pre-impregnated composite material and supplying the desired combination of two or more elements of pre-impregnated composite material to the calender;
a creel for storing the multiple elements of pre-impregnated composite material and for supplying the multiple elements of pre-impregnated composite material to the cut-and-add mechanism;
a band cutter for selectively cutting the band of uncured composite material, prior to forming;
a heater for heating the band of uncured composite material prior to forming;
a formed-part cutter for selectively cutting the formed, uncured composite material, subsequent to forming;
a conveyor for depositing the one or more, formed, uncured composite structures onto a curing tool;
an indexer adapted for operative connection to the curing tool, for indexing the curing tool as the one or more uncured composite structures are deposited onto the curing tool; and
a controller operatively connected to the apparatus for controlling the apparatus.
